(19) United States
(12) Patent Application Publication
(10) Pub. No.: US 2003/0212883 A1
(43) Pub. Date: Nov. 13, 2003

(54) Method and apparatus for dynamically managing input/output slots in a logical partitioned data processing system

(75) Inventors: Van Hoa Lee, Cedar Park, TX (US); David R. Willoughby, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/142,524

(22) Filed: May 9, 2002

(51) Int. Cl. G06F 15/177

(52) U.S. Cl. 713/1; 713/100

(57) ABSTRACT

A method, apparatus, and computer instructions for managing slots. In response to a request to deallocate a slot assigned to a partition within the logical partitioned data processing system, resources used for accessing the slot are disabled when the slot is unused in which a state of the slot changes to an isolated state when the resources are deallocated. The resources and ownership of the slot are unassigned from the partition when the slot is in the isolated state to place the slot in an unallocated state.

### CROSS REFERENCE TO RELATED APPLICATIONS

The present invention is related to the following applications entitled: “Method and Apparatus for Managing Memory Blocks in a Logical Partitioned Data Processing System”, Ser. No. ______, attorney docket no. AUS920020264US1; and “Method and Apparatus for Dynamically Allocating and Deallocating Processors in a Logical Partitioned Data Processing System, Ser. No. ______, attorney docket no. AUS920020265US1, all filed even date hereof, assigned to the same assignee, and incorporated herein by reference.

### BACKGROUND OF THE INVENTION

1. Technical Field

The present invention relates generally to an improved data processing system, and in particular, to a method and apparatus for managing components in a data processing system. Still more particularly, the present invention provides a method and apparatus for managing input/output slots in a logical partitioned data processing system.

2. Description of Related Art

A logical partitioned (LPAR) functionality within a data processing system (platform) allows multiple copies of a single operating system (OS) or multiple heterogeneous operating systems to be simultaneously run on a single data processing system platform. A partition, within which an operating system image runs, is assigned a non-overlapping subset of the platform's resources. These platform allocable resources include one or more architecturally distinct processors with their interrupt management area, regions of system memory, and input/output (I/O) adapter bus slots. The partition's resources are represented by the platform's firmware to the OS image.

Each distinct OS or image of an OS running within the platform is protected from each other such that software errors on one logical partition cannot affect the correct operation of any of the other partitions. This is provided by allocating a disjoint set of platform resources to be directly managed by each OS image and by providing mechanisms for ensuring that the various images cannot control any resources that have not been allocated to it. Furthermore, software errors in the control of an operating system's allocated resources are prevented from affecting the resources of any other image. Thus, each image of the OS (or each different OS) directly controls a distinct set of allocable resources within the platform.

With respect to hardware resources in a LPAR system, these resources are disjointly shared among various partitions, themselves disjoint, each one seeming to be a stand-alone computer. These resources may include, for example, input/output (I/O) adapters, memory dimms, non-volatile random access memory (NVRAM), and hard disk drives. Each partition within the LPAR system may be booted and shutdown over and over without having to power-cycle the whole system.

In reality, some of the I/O devices that are disjointly shared among the partitions are themselves controlled by a common piece of hardware, such as a host Peripheral Component Interface (PCI) bridge, which may have many I/O adapters controlled or below the bridge. The host bridge and the I/O adapters connected to the bridge form a hierarchical hardware sub-system within the LPAR system. Further, this bridge may be thought of as being shared by all of the partitions that are assigned to its slots.

Currently, when a system administrator wants to change resources given to different partitions, the partitions affected by the change must be brought down or shut down before these resources can be deallocated from one partition and reallocated to another partition. This type of deallocation and allocation capability is called static logical partitioning. This type of capability causes a temporary disruption of normal operation of the affected partitions. This temporary disruption of normal operation may affect users or other clients of the LPAR system.

Therefore, it would be advantageous to have an improved method, apparatus, and computer instructions for managing partitions in a LPAR system without requiring a disruption in operations of the affected partitions.

### SUMMARY OF THE INVENTION

The present invention provides a method, apparatus, and computer instructions for managing slots in a logical partitioned data processing system. In response to a request to deallocate a slot assigned to a partition within the logical partitioned data processing system, resources used for accessing the slot are disabled when the slot is unused in which a state of the slot changes to an isolated state when the resources are deallocated. The resources and ownership of the slot are unassigned from the partition when the slot is in the isolated state to place the slot in an unallocated state.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a block diagram of an exemplary logical partitioned platform in which the present invention may be implemented;

FIG. 3 is a diagram illustrating LPAR tables in accordance with a preferred embodiment of the present invention;

FIG. 4 is a flowchart of a process used for deallocating resources in a LPAR data processing system in accordance with a preferred embodiment of the present invention;

FIG. 5 is a flowchart of a process used for allocating a slot to a partition in accordance with a preferred embodiment of the present invention;

FIG. 6 is a flowchart of a process used to isolate a slot from a partition in accordance with a preferred embodiment of the present invention;

FIG. 7 is a flowchart of a process used to deallocate a slot in accordance with a preferred embodiment of the present invention;

FIG. 8 is a flowchart of a process used for allocating a slot to a partition in accordance with a preferred embodiment of the present invention; and

FIG. 9 is a flowchart of a process used for unisolating a slot in accordance with a preferred embodiment of the present invention.

### DETAILED DESCRIPTION OF THE PREFERRED EMBODIMENT

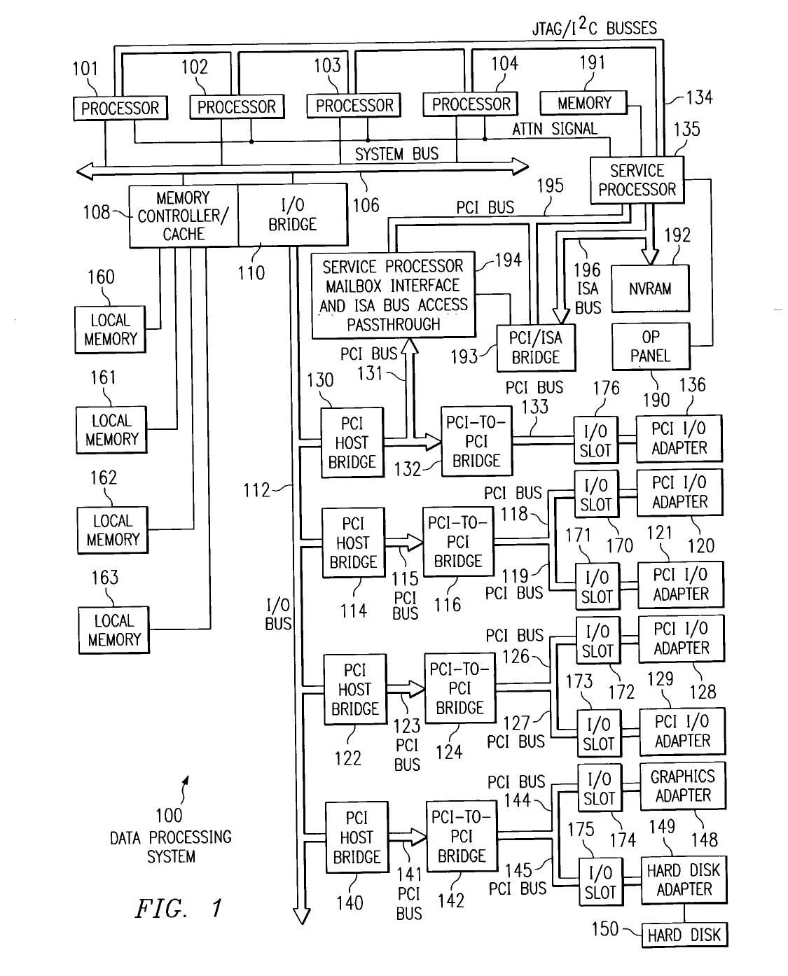

With reference now to the figures, and in particular with reference to FIG. 1, a block diagram of a data processing system in which the present invention may be implemented is depicted. Data processing system 100 may be a symmetric multiprocessor (SMP) system including a plurality of processors 101, 102, 103, and 104 connected to system bus 106. For example, data processing system 100 may be an IBM RS/6000, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logical partitioned such that different PCI I/O adapters 120-121, 128-129, and 136, graphics adapter 148, and hard disk adapter 149 may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and each of local memories 160-163 is assigned to one of the three partitions. For example, processor 101, local memory 160, and I/O adapters 120, 128, and 129 may be assigned to logical partition PI; processors 102-103, local memory 161, and PCI I/O adapters 121 and 136 may be assigned to partition P2; and processor 104, local memories 162-163, graphics adapter 148 and hard disk adapter 149 may be assigned to logical partition P3.

Each operating system executing within data processing system 100 is assigned to a different logical partition. Thus, each operating system executing within data processing system 100 may access only those I/0 units that are within its logical partition. Thus, for example, one instance of the Advanced Interactive Executive (AIX) operating system may be executing within partition P1, a second instance (image) of the AIX operating system may be executing within partition P2, and a Windows 2000 operating system may be operating within logical partition P1. Windows 2000 is a product and trademark of Microsoft Corporation of Redmond, Wash.

Peripheral component interconnect (PCI) host bridge 114 connected to I/O bus 112 provides an interface to PCI local bus 115. A number of PCI input/output adapters 120-121 may be connected to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations will support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 is connected to a plurality of PCI I/O adapters 128-129. PCT I/0 adapters 128-129 may be connected to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. In this manner, data processing system 100 allows connections to multiple network computers.

A memory mapped graphics adapter 148 inserted into I/O slot 174 may be connected to I/O bus 112 through PCI bus 144, PCI-to-PCI bridge 142, PCI bus 141 and PCI host bridge 140. Hard disk adapter 149 may be placed into I/O slot 175, which is connected to PCI bus 145. In turn, this bus is connected to PCI-to-PCI bridge 142, which is connected to PCI host bridge 140 by PCI bus 141.

A PCI host bridge 130 provides an interface for a PCI bus 131 to connect to I/O bus 112. PCI I/O adapter 136 is connected to I/O slot 176, which is connected to PCI-to-PCI bridge 132 by PCI bus 133. PCI-to-PCI bridge 132 is connected to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 are connected together to an interrupt input signal of the service processor. The service processor 135 has its own local memory 191, and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases the host processors 101-104 for execution of the code loaded into local memory 160-163. While the host processors 101-104 are executing code from respective operating systems within the data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

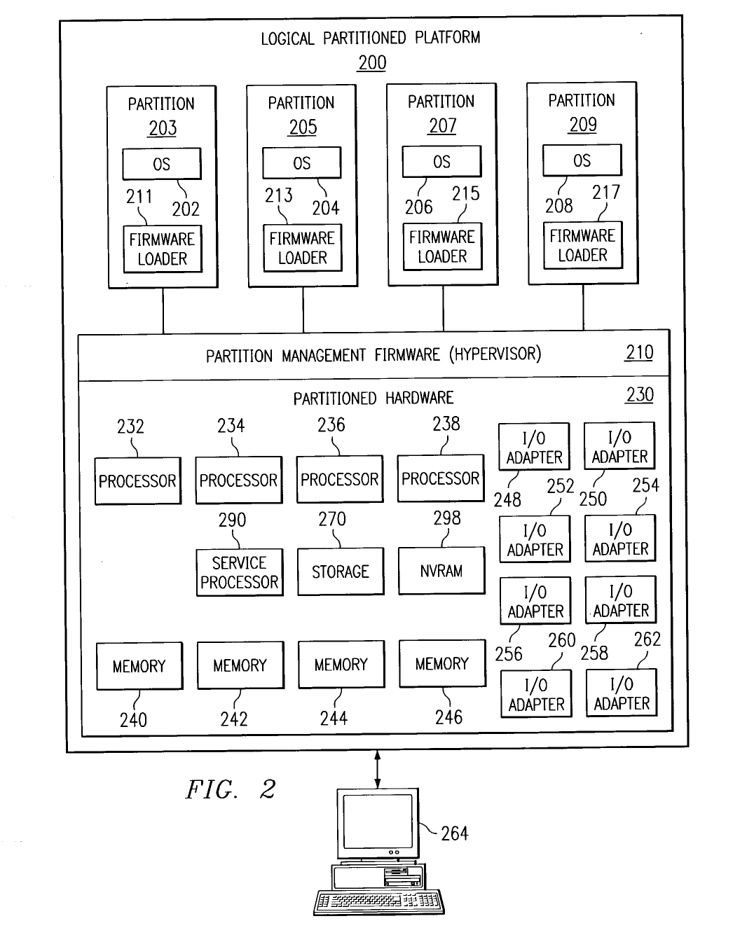

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and hypervisor 210. Operating systems 202, 204, 206, and 208 may be multiple copies of a single operating system or multiple heterogeneous operating systems simultaneously run on platform 200. These operating systems may be implemented using OS/400, which are designed to interface with a hypervisor. Operating systems 202, 204, 206, and 208 are located in partitions 203, 205, 207, and 209.

Additionally, these partitions also include firmware loaders 211, 213, 215, and 217. Firmware loaders 211, 213, 215, and 217 may be implemented using IEEE-1275 Standard Open Firmware and runtime abstraction software (RTAS), which is available from International Business Machines Corporation. When partitions 203, 205, 207, and 209 are instantiated, a copy of the open firmware is loaded into each partition by the hypervisor's partition manager. The processors associated or assigned to the partitions are then dispatched to the partitions' memory to execute the partition firmware.

Partitioned hardware 230 includes a plurality of processors 232-238, a plurality of system memory units 240-246, a plurality of input/output (I/O) adapters 248-262, and a storage unit 270. Partitioned hardware 230 also includes service processor 290, which may be used to provide various services, such as processing of errors in the partitions. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware (hypervisor) 210 performs a number of functions and services for partitions 203, 205, 207, and 209 to create and enforce the partitioning of logical partitioned platform 200. Hypervisor 210 is a firmware implemented virtual machine identical to the underlying hardware. Hypervisor software is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and non-volatile random access memory (non-volatile RAM). Thus, hypervisor 210 allows the simultaneous execution of independent OS images 202, 204, 206, and 208 by virtualizing all the hardware resources of logical partitioned platform 200.

Operations of the different partitions may be controlled through a hardware management console, such as console 264. Console 264 is a separate data processing system from which a system administrator may perform various functions including reallocation of resources to different partitions.

Turning next to FIG. 3, a diagram illustrating LPAR tables is depicted in accordance with a preferred embodiment of the present invention. In this example, LPAR tables are located in NVRAM 300 and system memory 302. NVRAM 300 may be implemented as NVRAM 298 in FIG. 2, and system memory 302 may be implemented as memory 244 in FIG. 2. The information in these tables is used for identifying what resources are assigned to particular partitions as well as status information.

In this example, in NVRAM 300, these tables include processor table 304, drawer table 306, input/output (I/O) slot assignment table 308, status/command table 310, and system resource table 312. Processor table 304 maintains a record for each of the processors located within the LPAR data processing system. Each record in this table may include, for example, an ID of the logical partition assigned to the processor, a physical location ID, a processor status, and a processor state.

Drawer table 306 includes a record for each drawer within the LPAR system in which each record may contain drawer status and the number of slots. A drawer is a location within a frame. Each drawer has some maximum number of slots into which processor nodes, I/O devices, and memory boards are mounted. Frames provide a mounting as well as power for various components.

I/O slot assignment table 308 includes a record for each slot in the LPAR system and may, for example, include a location code, an I/O device ID, and an ID of the partition assigned to the slot.

System memory 302 includes translation control entry (TCE) table 314, memory mapped input/output (MMIO) table 316, and interrupt table 318. These tables contain information used to identify resources used to access I/O slots. For example, TCE table 314 may include translation control entries (TCEs) for direct memory access (DMA) addresses for each slot. Additionally, memory mapped input/output (MMIO) addresses for slots are located in MMIO table 316. Further, interrupts assigned to the different slots also may be identified in interrupt table 318. This information is controlled and accessible by a hypervisor, such as hypervisor 210 in FIG. 2.

Status/command table 310 includes a record for each partition. This table may include a command state of the partition, a current command for the partition, and a last command for the partition.

System resource table 312 maintains information regarding resources available for the system. This table may include, for example, a maximum number of slots, a maximum number of processors, a maximum number of drawers, total memory installed, total memory allocated for the partitions, and time information.

The present invention provides an improved method, apparatus, and computer instructions for managing slots in a LPAR data processing system. The mechanism provides a dynamic management capability to deallocate and allocate slots to partitions without requiring the affected partitions to be terminated or shut down before the reallocation of these resources occurs.

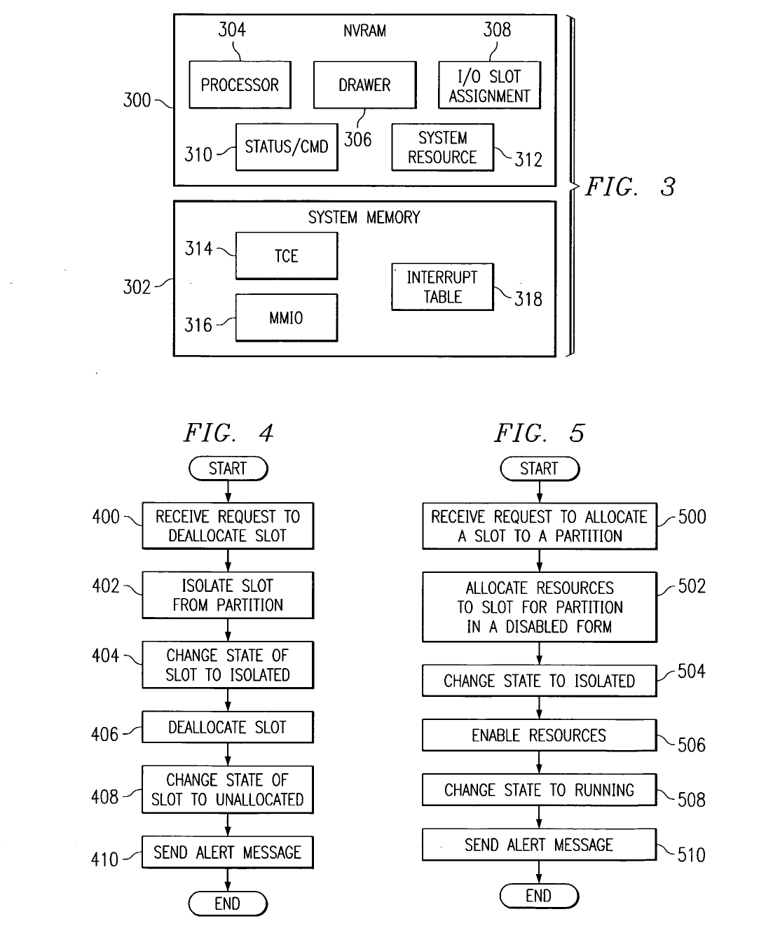

With reference now to FIG. 4, a flowchart of a process used for deallocating resources in a LPAR data processing system is depicted in accordance with a preferred embodiment of the present invention. The process illustrated in FIG. 4 may be implemented in a logical partitioned platform, such as logical partitioned platform 200 in FIG. 2.

The process begins by receiving a request to deallocate a slot (step 400). This request may be received from a user at a console, such as console 264 in FIG. 2. The request is received by the operating system in a partition, such as operating system 202 in partition 203 in FIG. 2. The operating system makes a call to the RTAS of firmware loader, such as firmware loader 211 in FIG. 2, to isolate the slot. This request may be made, for example, through a rtas_set_indicator( ) call. In this example, an existing firmware loader function call is used for a different purpose in which a parameter identifying an action to be taken is sent with the call.

The slot is isolated from the partition (step 402). The firmware loader will make sure that if an adapter is present in the slot that it has been isolated from the PCI bus. Such an assumption is made with respect to this flow. Otherwise, the firmware loader will send an indication back that the adapter must be isolated prior to isolation of the slot. In isolating the slot, the firmware loader makes a call to a partition management firmware, such as partition management firmware 210 in FIG. 2. This firmware is also referred to as a “hypervisor”. In this example, the hypervisor performs actions needed to isolate the slot. In essence, resources used for accessing the slot are disabled.

Next, the state of the slot is changed from running to isolated (step 404). The state change is used by the hypervisor to make sure the deallocation is following the flow of the process. For example, if operating system calls are made to an unallocated slot, but the state of the slot is not in an isolated state, the call will be immediately rejected. An operating system initiates different steps in the deallocation and allocation process based on the successful completion of the previous step in the process. At this point, the operating system is ready to deallocate the slot from the partition so that the slot becomes an available resource for assignment to another partition.

The slot is then deallocated (step 406). The deallocation in step 406 is accomplished by the operating system making a rtas_set_indicator( ) call to the firmware loader. In turn, the firmware loader performs a hypervisor call to the hypervisor to deallocate resources used to access the slot. Thereafter, the state of the slot is changed from isolated to unallocated (step 408), and an alert message is sent to the console (step 410) with the process terminating thereafter.

Turning next to FIG. 5, a flowchart of a process used for allocating a slot to a partition is depicted in accordance with a preferred embodiment of the present invention. The process illustrated in FIG. 5 may be implemented in a logical partitioned platform, such as logical partitioned platform 200 in FIG. 2.

The process begins by receiving a request to allocate a slot to a partition (step 500). This request is received from a console, such as console 264 in FIG. 2. The request is received by the partition that is to receive the allocation. In response, the operating system makes a call to the firmware loader to allocate the assigned slot to the partition. In turn, the firmware loader ensures that the I/O slot identified exists within the LPAR data processing system and makes a call to the hypervisor to perform the allocation of resources needed to access the slot. Resources are then allocated to the slot for the partition in a disabled form (step 502).

The state is changed to isolated (step 504). When the operating system detects that the slot has now been changed from unallocated to isolated, a rtas_set_indicator( ) call is made by the operating system to the firmware loader to unisolate the slot. The firmware loader then makes calls to the hypervisor to enable resources to allow the partition to access the slot. The resources are then enabled by the hypervisor (step 506). Afterwards, the state of the slot is changed from isolated to running (step 508), and an alert message is sent to the console (step 510) with the process terminating thereafter.

At this point, the slot is in normal operation and the operating system may perform a rtas_get_sensorvalues( ) call to the firmware loader to detect whether an adapter is present in the slot. Thereafter, a PCI reset signal to the adapter is removed such that the adapter is no longer isolated from the PCT bus. The firmware loader then builds and returns the device node and device property of the slot to the operating system.

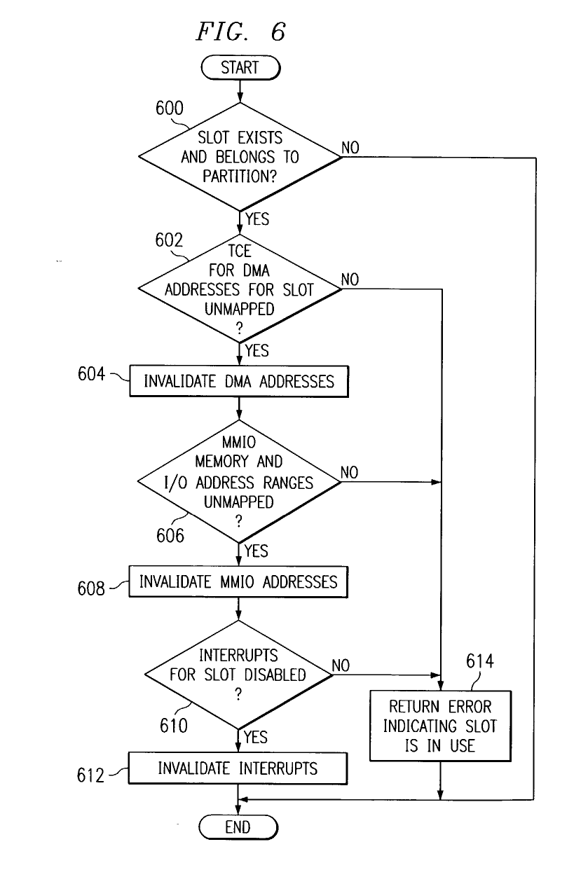

With reference now to FIG. 6, a flowchart of a process used to isolate a slot from a partition is depicted in accordance with a preferred embodiment of the present invention. The process illustrated in FIG. 6 is a more detailed description of step 402 in FIG. 4. The steps illustrated in FIG. 6 are examples of steps performed by the hypervisor in isolating the slot.

The process begins by determining if a slot exists and belongs to the partition (step 600). If the slot exists and does belong to the partition, a determination is made as to whether the translation control entries (TCEs) for direct memory access (DMA) addresses for the slot are unmapped (step 602). This step is used to ensure that data transfers are not occurring with respect to the slots. If the addresses are mapped, then an operation is outstanding. If the TCE for DMA addresses for the slot are unmapped, the DMA addresses are invalidated (step 604). This invalidation prevents DMA operations from occurring with respect to the slot.

Next, a determination is made as to whether MMIO memory and I/O address ranges are unmapped in the page table used by the partition's processors (step 606). This step is used to ensure that control registers in the adapter in the slot are not being accessed by the partition. If MMIO memory and I/O address ranges are unmapped, MMIO addresses are invalidated (step 608). This step prevents access to the control registers. Next, a determination is made as to whether the interrupts for the slot are disabled (step 610). If the interrupts for the slot are disabled, the interrupts are invalidated (step 612) and the process terminates thereafter. All of these steps are performed to prevent the partition operating system from using the hardware resources associated with the slot.

Referring again to step 610, if the interrupts for the slot are not disabled, an error indicating that the slot is in use is returned (step 614), and the process terminates thereafter. With reference again to step 606, if MMIO memory and I/O address ranges are unmapped, the process proceeds to step 614 as described above. Turning again to step 602, if the TCE for DMA addresses for the slot are not unmapped, the process also proceeds to step 614 as described above.

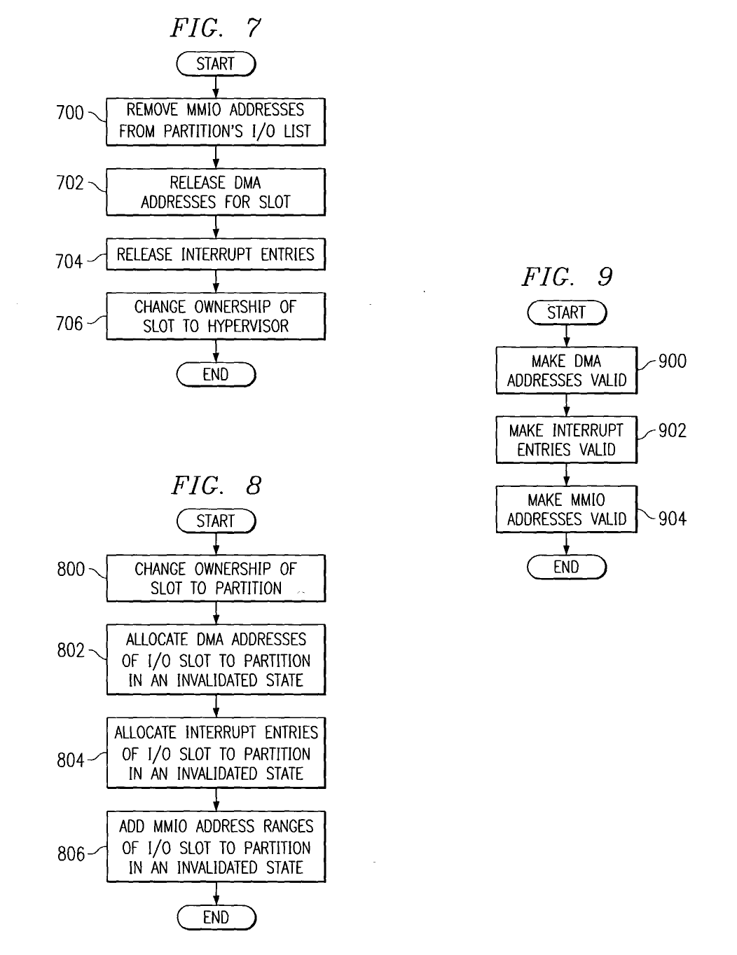

Turning now to FIG. 7, a flowchart of a process used to deallocate a slot is depicted in accordance with a preferred embodiment of the present invention. The process illustrated in FIG. 7 is a more detailed description of step 406 in FIG. 4.

The process begins by removing the MMIO addresses from the partition's I/O list (step 700). Each partition has a MMIO address list which is used to keep track of all the MMIO addresses of the I/O slots belonging to the partition. This type of detailed information is platform specific. This removal of the MMIO addresses means that the partition no longer owns or is able to use these addresses. The DMA addresses for the slot are released to the hypervisor (step 702). The interrupt entries are released (step 704). These interrupt entries are released back to the control of the hypervisor. Ownership of the slot is changed (step 706). The ownership is changed from the partition to the hypervisor in step 706 and the process terminates thereafter.

With reference next to FIG. 8, a flowchart of a process used for allocating a slot to a partition is depicted in accordance with a preferred embodiment of the present invention. The process illustrated in FIG. 8 is a more detailed description of step 502 in FIG. 5.

The process begins by changing ownership of the slot to the partition (step 800). DMA addresses of I/O slots are allocated to the partition in an invalidated state (step 802). The addresses are allocated in an invalidated state on a temporary basis to prevent the partition from accessing the slot until all of the allocations have been performed. Interrupt entries of the I/O slot are allocated to the partition in invalidated state (step 804). MMIO address ranges of the I/O slot are added to the partition in an invalidated state (step 806) and the process terminates thereafter.

Turning now to FIG. 9, a flowchart of a process used for unisolating a slot is depicted in accordance with a preferred embodiment of the present invention. The process illustrated in FIG. 9 is a more detailed description of step 506 in FIG. 5.

The process begins by making DMA addresses valid (step 900). By making the DMA addresses valid addresses, an adapter plugged into the slot may use these addresses to perform DMA operations in transferring data. Interrupt entries are made valid (step 902). With valid interrupt entries being present, the adapters may use these interrupt entries to raise interrupts to a device driver for the adapter. MMIO addresses are made valid, which allows the operating system to assign them to an adapter located in the slot (step 904) and the process terminates thereafter.

Thus, the present invention provides a method, apparatus, and computer instructions for dynamically reallocating slots in a LPAR data processing system. The mechanism of the present invention allows for a slot to be reallocated from one partition to another partition without having to terminate or shut down operation of the affected partitions. The mechanism involves isolating a slot from the partition by preventing access to resources normally used to access the slot. Thereafter, these resources are unassigned or reassigned to the hypervisor with the resources then later being reassigned to a desired partition. In the reassignment of these resources, the resources remain in an invalid or unusable state while the allocation occurs to prevent the partition from attempting to access the slot. After the allocations are completed, the resources are validated or enabled for use by the partition. The steps of isolating the slot before deallocation or allocation prevents errors occurring by a partition attempting to access the slot using the resources. This isolation also prevents an adapter in the slot from attempting to access the partition before the allocation is completed.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the particular components illustrated as participating in the management of input/output slots are an operating system, a RTAS, and a hypervisor. These particular components are described for purposes of illustration and are not intended to limit the manner in which the processes for the dynamic allocation may be implemented. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a logical partitioned data processing system for managing slots, the method comprising:
responsive to a request to deallocate a slot assigned to a partition within the logical partitioned data processing system, disabling resources used for accessing the slot when slot is unused, wherein a state of the slot changes to an isolated state when the resources are deallocated; and
unassigning the resources and ownership of the slot from the partition when the slot is in the isolated state to place the slot in an unallocated state.

2. The method of claim 1 further comprising:
responsive to a request to allocate the slot to a selected partition, changing ownership of the slot to the selected partititon;
responsive to a request to allocate the slot to the selected partition, allocating resources for accessing the slot to the partition, wherein the resources are invalidated; and
changing the resources such that the resources are validated for use by the partition to access the slot.

3. The method of claim 1, wherein the resources include at least one of interrupts, memory mapped input/output addresses, and direct memory access addresses.

4. The method of claim 1, wherein the slot is an input/output peripheral component interconnect slot.

5. The method of claim 1 further comprising:
sending a message, indicating the unallocated state, to a console.

6. The method of claim 2 further comprising:
sending a message, indicating a running state, to a console.

7. A method in a logical partitioned data processing system for managing slots, the method comprising:
responsive to a request to deallocate a slot assigned to a partition within the logical partitioned data processing system, isolating the slot from the partition; and
deallocating the slot after the slot has been isolated from the partition.

8. The method of claim 7, wherein the isolating step comprises:
invalidating resources used by the partition to access the slot to form invalidated resources; and
changing a state of the slot to an isolated state.

9. The method of claim 8, wherein the deallocating step comprises:
unallocating the invalidated resources from the partition; and
changing the state of the slot to an unallocated state.

10. The method of claim 7, futher comprising:
responsive to a request to allocate a slot to the partition, allocating resources for accessing the slot to the partition in a disabled state; and
changing the resources to an enabled state such that the slot may be accessed by the partition.

11. The logical partitioned data processing system for managing slots, the logical partitioned data processing system comprising:
a bus system;
a communications unit connected to the bus system;
a memory connected to the bus system, wherein the memory includes a set of instructions; and
a processing unit connected to the bus system, wherein the processing unit executes the set of instructions to disable resources used for accessing the slot when slot is unused in which a state of the slot changes to an isolated state when the resources are deallocated in response to a request to deallocate a slot assigned to a partition within the logical partitioned data processing system; and unassign the resources and ownership of the slot from the partition when the slot is in the isolated state to place the slot in an unallocated state.

12. The logical partitioned data processing system of claim 11, wherein the processing unit further executes the set of instructions to change ownership of the slot to the selected partititon in response to a request to allocate the slot to a selected partition; allocate resources for accessing the slot to the partition in which the resources are invalidated in response to a request to allocate the slot to the selected partition; and change the resources such that the resources are validated for use by the partition to access the slot

13. A data processing system in a logical partitioned data processing system for managing slots, the logical partitioned data processing system comprising:
a bus system;
a communications unit connected to the bus system;
a memory connected to the bus system, wherein the memory includes a set of instructions; and
a processing unit connected to the bus system, wherein the processing unit executes the set of instructions to isolate the slot from the partition in response to a request to deallocate a slot assigned to a partition within the logical partitioned data processing system; and deallocate the slot after the slot has been isolated from the partition.

14. The logical partitioned data processing sytem of claim 13, wherein the processing unit further executes the set of instructions to invalidate resources used by the partition to access the slot to form invalidated resources; and change a state of the slot to an isolated state.

15. A logical partitioned data processing system for managing slots, the data processing system comprising:
disabling means, responsive to a request to deallocate a slot assigned to a partition within the logical partitioned data processing system, for disabling resources used for accessing the slot when slot is unused, wherein a state of the slot changes to an isolated state when the resources are deallocated; and
unassigning means for unassigning the resources and ownership of the slot from the partition when the slot is in the isolated state to place the slot in an unallocated state.

16. The data processing system of claim 15 further comprising:
first changing means, responsive to a request to allocate the slot to a selected partition, for changing ownership of the slot to the selected partititon;
allocating means, responsive to a request to allocate the slot to the selected partition, for allocating resources for accessing the slot to the partition, wherein the resources are invalidated; and
second changing means for changing the resources such that the resources are validated for use by the partition to access the slot.

17. The data processing system of claim 15, wherein the resources include at least one of interrupts, memory mapped input/output addresses, and direct memory access addresses.

18. The data processing system of claim 15, wherein the slot is an input/output peripheral component interconnect slot.

19. The data processing system of claim 15 further comprising:
sending means for sending a message, indicating the unallocated state, to a console.

20. The data processing system of claim 16 further comprising:
sending means for sending a message, indicating the running state, to a console.

21. A data processing system in a logical partitioned data processing system for managing slots, the data processing system comprising:
isolating means, responsive to a request to deallocate a slot assigned to a partition within the logical partitioned data processing system, for isolating the slot from the partition; and
deallocating means for deallocating the slot after the slot has been isolated from the partition.

22. The data processing system of claim 21, wherein the isolating means comprises:
invalidating means for invalidating resources used by the partition to access the slot to form invalidated resources; and
changing means for changing a state of the slot to an isolated state.

23. The data processing system of claim 22, wherein the deallocating means comprises:
unallocating means for unallocating the invalidated resources from the partition; and
changing means for changing the state of the slot to an unallocated state.

24. The data processing system of claim 21, futher comprising:
allocating means, responsive to a request to allocate a slot to the partition, for allocating resources for accessing the slot to the partition in a disabled state; and
changing means for changing the resources to an enabled state such that the slot may be accessed by the partition.

25. A computer program product in a computer readable medium for managing slots, the computer program product comprising:
first instructions, responsive to a request to deallocate a slot assigned to a partition within the logical partitioned data processing system, for disabling resources used for accessing the slot when slot is unused, wherein a state of the slot changes to an isolated state when the resources are deallocated; and
second instructions for unassigning the resources and ownership of the slot from the partition when the slot is in the isolated state to place the slot in an unallocated state.

26. The computer program product of claim 25 further comprising:
third instructions, responsive to a request to allocate the slot to a selected partition, for changing ownership of the slot to the selected partititon;
fourth instructions, responsive to a request to allocate the slot to the selected partition, for allocating resources for accessing the slot to the partition, wherein the resources are invalidated; and
fifth instructions for changing the resources such that the resources are validated for use by the partition to access the slot.

27. A computer program product in a computer readable medium for managing slots, the computer program product comprising:
first instructions, responsive to a request to deallocate a slot assigned to a partition within the logical partitioned data processing system, for isolating the slot from the partition; and
second instructions for deallocating the slot after the slot has been isolated from the partition.

28. The computer program product of claim 27, wherein the first instructions comprises:
first sub-instructions for invalidating resources used by the partition to access the slot to form invalidated resources; and
second sub-instructions for changing a state of the slot to an isolated state.
